(19) United States
(12) Patent Application Publication
(10) Pub. No.: US 2023/0368139 A1
(43) Pub. Date: Nov. 16, 2023

(54) PEER DISSIMILARITY IDENTIFICATION AND PROFILE GENERATION

(71) Applicant: Dell Products L.P., Round Rock, TX (US)

(72) Inventors: Ming Qian, Allston, MA (US); Nicole Reineke, Northborough, MA (US); Radia J. Perlman, NE. Redmond, WA (US)

(21) Appl. No.: 17/663,422

(22) Filed: May 14, 2022

(51) Int. Cl. G06Q 10/10; G06K 9/62

(52) U.S. Cl. CPC G06Q 10/101; G06K 9/6215; G06Q 10/103

(57) ABSTRACT

Selecting a review panel of dissimilar peers. An asset is reviewed from an ethical perspective by a panel of reviewers. The panel of reviewers includes members that are selected based on their dissimilarity to creators of the asset. Selecting dissimilar members for the panel of reviewers allows bias in the asset to be identified and remedied. A portion of the panel of reviewers may be selected randomly to further improve the effectiveness of the panel of reviewers in reviewing the asset for ethicalness.

### FIELD OF THE INVENTION

Embodiments of the present invention generally relate to peer dissimilarity identification and to identifying dissimilarities. More particularly, at least some embodiments of the invention relate to systems, hardware, software, computer-readable media, and methods for identifying or selecting a dissimilar panel of reviewers to evaluate an asset for bias.

### BACKGROUND

Extensive research to identify bias in artificial intelligence and machine learning (AI/ML) suggests that assets (e.g., code, algorithms, papers) require human inspection. Inspections tend to be more effective when performed by dissimilar people. Stated differently, the ability to identify biases and to detect (or prevent) ethical violations is improved when those that conduct the bias review are dissimilar from each other.

Assets such as artificial intelligence or other algorithms can produce unethical insights. Artificial intelligence, for example, may factor race into decisions to grant mortgages or exclude women from resume analysis. Search engines can return results that are biased against minorities. College application analytics can exclude certain groups from consideration. These results reflect a bias in the artificial intelligence. Bias in automated algorithms or in artificial intelligence can impact society in a negative manner. Further companies that engage in biased behavior, even if unintentional, may be subject to monetary penalties.

However, identifying a sufficiently diverse panel of reviewers to review assets for ethicalness is difficult. Some aspects of diversity can be obvious, such as when a panel of reviewers to review assets includes diverse genders. More generally, it is difficult to understand what makes any particular group diverse. For example, selecting a panel of reviewers that have diversity with regard to multiple factors or characteristics such as socioeconomic upbringing or political leaning, is more difficult to achieve.

The process of identifying a diverse group of individuals is further complicated by the fact that different contexts require different types of diversity in order to ensure ethicalness. An algorithm that detects politeness may require a panel of reviewers with cultural variation while an algorithm that detects loan fitness may require a panel of reviewers with gender and race diversity.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of a selection engine configured to select a panel of reviewers to review an asset;

FIG. 2 discloses aspects of a data structure for ethics review;

FIG. 3 discloses aspects of a method for selecting a panel of reviewers to evaluate an asset;

FIG. 4 discloses aspects of a computing device, system, or entity; and

FIG. 5 discloses aspects of a computing device, a computing system, or a computing entity.

### DETAILED DESCRIPTION OF SOME EXAMPLE EMBODIMENTS

Embodiments of the present invention generally relate to ethicalness in artificial intelligence and machine learning. More particularly, at least some embodiments of the invention relate to systems, hardware, software, computer-readable media, and methods for selecting or identifying members to include in a panel of reviewers that is suitably diverse and that accounts for the context of an asset subject to ethical review.

Embodiments of the invention help an entity avoid ethical violations and improve the ability of assets (e.g., products, algorithms) to operate with less bias by identifying resources (e.g., members of a review panel) to be used in ethical assessments or ethical reviews.

An entity, for example, may be developing an asset (e.g., a computing application) that is planned for release to the public. A governing body of the entity is tasked with evaluating or judging the ethicalness of the asset and/or responsible for releasing the asset. Embodiments of the invention allow the governing body to select and/or identify a panel of reviewers to review the asset from an ethical perspective. The asset can be reviewed in a manner that reduces or minimizes the impact of bias, including unintended bias. Because the members of the panel of reviewers identified/selected in accordance with embodiments of the invention are diverse and because the context of the asset is considered, the ability to identify and/or eliminate bias in the asset or in the operation thereof is improved.

More specifically, reviewing an asset such as artificial intelligence or machine learning models from an ethical perspective reduces or eliminates negative societal impacts and may prevent fines. Embodiments of the invention, in identifying or selecting the panel of reviewers, may identify/select reviewers that are peers to the development team or that are skilled in the art relevant to the asset, dissimilar from the creator of the original asset, and consider aspects of dissimilarity (the context) that are appropriate for reviewing the asset. By way of example, embodiments of the invention may account for measurable human aspects, multiple known biases, asset intent or the context in which the asset is intended to be used, structured dissimilarity detection, and randomization for use in learned aspect mapping. Embodiments of the invention decrease the likelihood that an inherently flawed asset will be released.

Embodiments of the invention relate to a peer selection engine that is configured to select or identify a panel of reviewers to review or evaluate an asset. The asset may have different forms, such as by way of example only, an algorithm, artificial intelligence, machine learning models, drugs, products, code, test groups, groups of people, or the like or combination thereof.

Identifying or selecting the members to include on the panel of reviewers can be based solely on the output or inferences generated by a machine learning model or by artificial intelligence. In another example, at least a portion of the members may be selected in another manner, such as randomly. More specifically, a portion of the panel of reviewers may be selected by performing a random walk in a data set of candidate reviewers. In a random walk, a data point (which may be a potential member of the review group) is selected and a walk is then performed randomly or based on probability distributions to other data points. Explicitly selecting dissimilar members and/or selecting random members improves the ability of the panel of reviewers to identify bias in the asset.

For example, when the asset is an artificial intelligence or a machine learning model (AI/ML), dissimilar members on a panel of reviewers are more likely to reduce any bias in the decision making performed by the AI/ML. In one embodiment, the dissimilarity is measured, by way of example only, with respect to a creator or developer of the asset, the asset, and/or other members of the panel of reviewers.

In an example where the asset is an AI/ML, the selection engine may consider the experience and familiarity of the asset's creator, the experience and familiarity of the reviewers with relevant algorithms, their development experiences, past products on which the reviewers and creator have worked (together and/or separately), and the like to evaluate the similarity or dissimilarity between the reviewers and the creator(s) of the asset.

Embodiments of the invention have applicability in any area where selecting a diverse set of people (or of objects) is beneficial. For example, embodiments of the invention can be applied to educational or justice related group selection processes in order to improve the fairness and diversity of the selections. For example, an AI/ML admissions engine (admissions engine) may be created and configured to aid in the selection of students to admit to a school.

In one example, the admissions engine may be reviewed for bias as discussed herein. This allows the admissions engine to select applicants in a fairer manner. In this example, the admission office may filter the profiles of all applicants based on their baseline admission criteria to generate a pool of applicants. After the initial selection of the pool of applicants, the data of the applicants in the pool of applicants are input to the admissions engine, which is configured to select or identify a diverse set of students for admission in an intentional and/or random manner. The admissions engine may identify dissimilar students based on factors relevant to the school (the context) such as gender, ethnicity, athlete types, culture background, or the like. Assuming that there are a sufficient number of applicants, the admission engine may identify of select a diverse set of qualified applicants without requiring or considering potentially politically charged criteria such as racial quotas or other criteria that could be interpreted as a biased selection process.

Another example relates to the process of selecting a jury. Currently, the jury selection process involves substantial human intervention that may be highly subjective, unfair and biased because lawyers from both sides will choose the members of the jury based on their own best interests. These “best interest” evaluations inevitably involve subjective judgement and personal beliefs that could easily be misleading or biased. Thus, embodiments of the invention may be applied to review the ethicalness of a jury selection engine such that a fair and representative jury is selected.

After being evaluated for bias (and corrected) the jury selection engine is configured to increase the fairness of members selected to serve on the jury. The jury selection engine (AI/ML) may consider specific key factors are important to evaluating the jury candidates on for a particular trial. For example, during the murder trial of O. J. Simpson in 1994, the jury selection process was influenced by two key factors: race and gender. The lawyers for the defendant selected black male jury candidates.

In some examples, race and gender should not be the dominant key factors that are critical for one trial. In embodiments of the invention, the key factors may be determined based on the analysis of historical trials including similar trials. Moreover, all the potential jury candidates will be evaluated by the jury selection engine based on their basic information, their specific case related background, and the key factors. The members of the jury will be selected based on the similarity and dissimilarity level against what the lawyers are trying to find. Then the jury selection engine will explicitly pick a jury that includes members whose selection is based on dissimilarity and members that are selected randomly. This may result in a jury that is fairer for a specific case.

Embodiments of the invention are not limited to selecting members to be included on a review panel, applicants from a pool of applicants, or persons to serve on a jury. Embodiments of the invention may also be applied to objects in general and are able to identify a dissimilar set of objects from the candidate objects. For example, embodiments of the invention may be able to select diverse candidates for testing drugs in development, or the like.

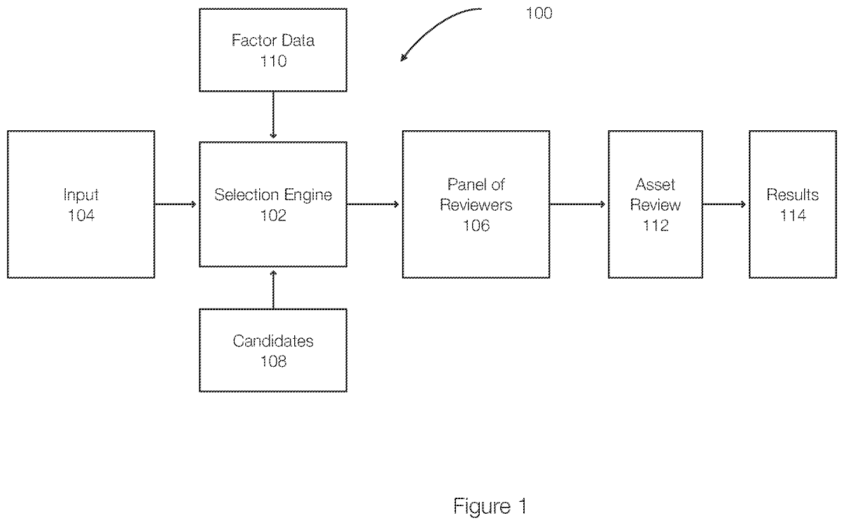

FIG. 1 discloses aspects of peer dissimilarity identification. The system 100 may include a selection engine 102 that is configured to identify/select a panel of reviewers 106 from a pool of candidates 108. The panel of reviewers 106 identified or selected from the candidates 108 includes candidates that are dissimilar with respect to each other and/or a creator/developer of an asset being evaluated.

The following example uses the selection engine 102 to identify or select a panel of reviewers to evaluate an artificial intelligence or a machine learning model (the asset) created by a creator. The creator may be an individual, a team of individuals, or the like. This example assumes that the review occurs after asset development is completed. However, the review may be conducted at any time.

After the asset is developed and ready for review, asset materials are complied. This information may include, but is not limited to, product intent, product industry and influenced factors, personnel information (e.g., asset developers, data scientists, product managers and others related to the creation and development of the asset). The compiled information is part of the input 104 to the selection engine 102.

The selection engine 102 may also pull or access other factor data 110 such as industry regulations and key factors data. This allows the selection engine 102 to analyze and define the factors that are key for analyzing the context and specific product. In one example, these factors (or other of the input 104) may serve as initial centroids in k-means clustering algorithms.

In one example, the input 104 and/or the factors 110 generally includes the data related to the personnel information associated with the creation and development of the asset.

The candidates 108 include a pool of potential panelists that will be responsible for evaluating the asset. The personnel information is analyzed against similar information associated with the candidates 108 and at least a portion of the panel of reviewers 106 is identified by the selection engine 102 based on dissimilarity. Another portion of the panel of reviewers 106 may be selected from the candidates 108 randomly. In this example, the candidates 108, when viewed as input to the selection engine 102, includes information associated with the candidates and includes information similar to the information about the creator/developer that is included in the input 104 and/or the factor data 110.

Once the panel of reviewers 106 is assembled or selected by the selection engine 102, an asset review 112 may be performed. The results 114 can be provided to the creator or developer, who may then make changes to the asset to eliminate any bias or other problem included or identified in the results 114.

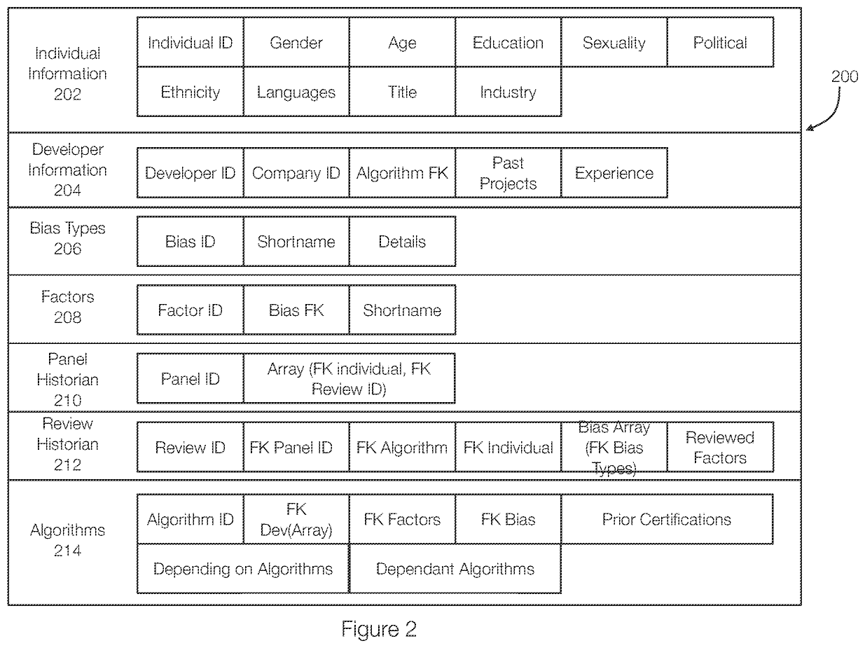

FIG. 2 discloses aspects of a data structure that may store data used in the context of ethically reviewing a product or other object. The structure 200 may include table entries such as individual information 200, developer information 204, bias types 206, factors 208, a panel historian 210, a review historian 212, and algorithms 214. The individual information may include an identifier, a gender type, an age (number), an education (level), a sexuality, a political category, an ethnicity type, languages, a title or role, and an industry. These values, which are presented by way of example, allow an individual to be associated with multiple characteristics. The information included in the structure 200 is an example of data that is input to the selection engine on both the creator/development personnel and the pool of candidates from which the panel of reviewers is selected.

The developer information 204 may include a developer identifier, a company identifier, an algorithm key, past projects information, and experience (level). This allows the developer to be associated with multiple characteristics. The developer information can be provided for members in the pool of candidates, at least because they may be developers of other assets.

The bias types 206 may include a list of biases and includes a bias ID, a short name, and details. Examples include an affinity bias, a confirmation bias, anchoring bias, and the like. There are over one hundred known biases.

The factors 208 may include a factor identifier, a bias key, and a short name. The factors relevant to a particular asset may depend, at least in part, on asset intent. The relevant factors may also be determined based, in part, on a historical analysis of previous panel selections and asset types. For example, the factors may include factors related to relevant industry standards, standard or known asset checks, or the like. For example, key factors for school admission may include gender, ethnicity, athlete types, culture background, or the like.

The panel historian 210 may provide information related to previous panels. The panel historian 210 may include a panel identifier and an array associating individuals with previous reviews. The review historian 212 is configured to store a history of panel selections and the associated algorithms, biases, factors, and the like.

The algorithms 214 stored information about the algorithms that may be included in the produce or AI being reviewed. This may include factors, bias, certifications that the product has passed, and algorithms that depend on the asset and algorithms the asset is dependent on.

In one example, the data structure 200 may include metadata, including human-centric metadata such as demographic information and history that allows biases and humans to be plotted (e.g., in a graph). Subsequent use of asset context detection can refine the metadata or bias such that an index cluster can be generated to create groups of peers. This group of peers is then assigned to a review activity (captured in the panel historian) and their responses are recorded in the review historian for use in future panel generation.

Generating and plotting metadata on these types of characteristics and on detected and missed detection of biases may allow a least alike data set to be generated and allows a dissimilar set of reviewers to be assigned to a panel of reviewers. For example, determining the K for a k-means cluster may plot people based on the metadata. This can also be used as a starting point for the n-walks to pick randomized humans for assignment into a panel of reviewers or other group.

When generating a panel of reviewers, the use of random assignments along with the use of dissimilar assignment may facilitate the detection of vertices of bias for use in subsequent cluster definitions. The combination of dissimilar assignment and random assignment may allow the panel of reviewers to detect additional points of bias that are not found using a panel of reviewers that is selected using dissimilarities alone. This is useful in the discovery of new points of bias or new “K's along which to define vertices.

In addition, audit trails can be used to detect changes in review behaviors over time, which allows further diverse data sets to be built.

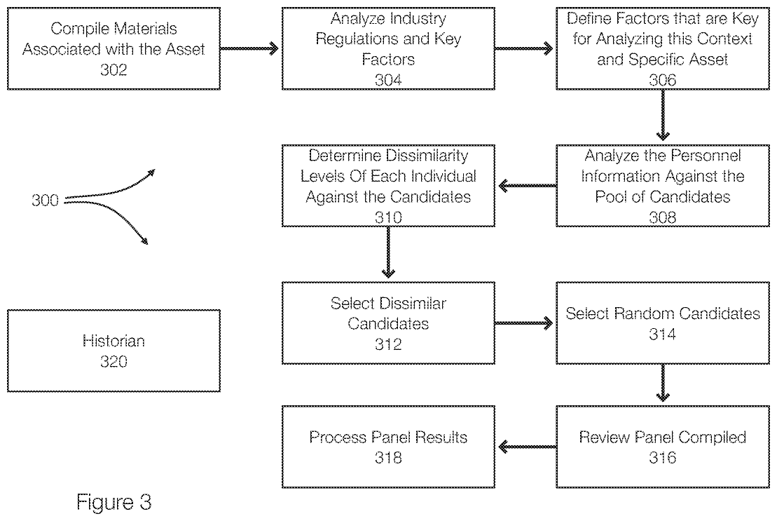

FIG. 3 discloses aspects of evaluating an asset for bias by selecting a diverse panel of reviewers. By way of example only, the asset being evaluated may be an artificial intelligence or machine learning model or other algorithm. In the method 300, an asset has been developed and is ready for a review by a panel of reviewers. In one example, a goal of the method 300 is to identify a diverse set of panelists such that bias in the asset can be detected and/or remedied. For example, with regard to an AI that determines whether an individual qualifies for a loan, a panel of reviewers consisting of a single race may not recognize that the AI is biased with regard to other races. Selecting a panel that is diverse with respect to race ensures that the asset can be configured to operate with less or no bias.

Initially, materials associated with the asset are compiled 302. These materials may include, by way of example, the assent intent, the industry, influenced factors, personnel information (of developers, data scientists, product managers), used data sets, used models or algorithms.

Next, industry regulations and key factors are analyzed 304. The key factors may be based on existing regulation related information, industry standards, and a historical analysis of similar assets. Thus, the identification of key factors is not limited to the current asset but allows key factors to be identified based on historical importance. As illustrated in FIG. 2, many of the tables are related to each other and/or to external data sources. These relationships facilitate the identification of dissimilarities.

Analyzing 304 industry regulations and factors may include generating a filtered list of bias types and/or factors. Next, the factors that are key for analyzing the context and specific asset are determined 306.

The creator personnel information associated with the creator and/or the developer is analyzed 308 against the pool of candidates. Similar information may be available for the pool of candidates. This allows dissimilarity levels between each individual (e.g., associated with the creator or developer) against each of the candidates to be determined 310. In one example, dissimilarity is determined as the distance between the development personnel versus the pool of candidates. The distance can be determined using, by way of example, k-means clustering.

Once these distances are determined, dissimilar candidates can be selected 312. In one example, only a portion (e.g., 50%) of the panel of reviewers are selected based on dissimilarities. The percentage may be based on need. Another portion (e.g., 50%) may be selected randomly 314.

This allows the panel of reviewers to be compiled 316. The panel may conduct the review and the results are processed 318. This may include selecting bias findings, adding new biases, or the like. The historian 320 records the results and the process. The historian 320 may store the selected panel, the decisions of the panel, the identified biases, or the like. This information is also associated with the asset may become part of the historical information used in selecting subsequent panels.

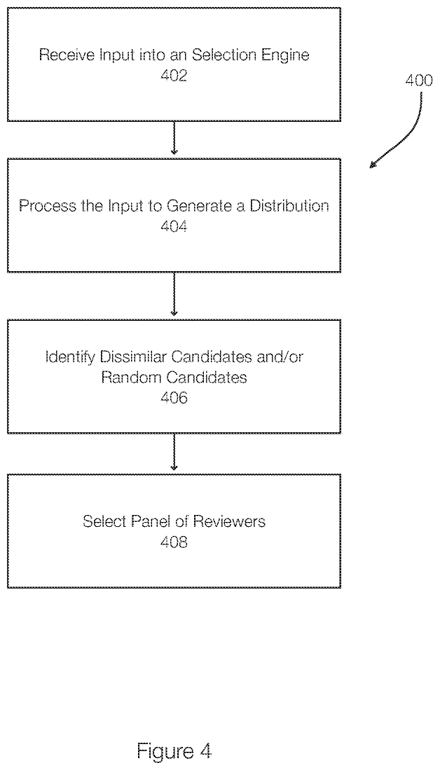

FIG. 4 discloses aspects of a method for selecting a panel of reviewers to review an asset. In the method 400, input is received 402 into a selection engine. The input may include information related to (e.g., metadata, characteristics) a creator (representative of any individual that was associated with or participated in the creation and development of the asset). The input may also include similar information related to candidates for the panel of reviewers. The information may include personal characteristics (e.g., age, sex, political category, gender), peer related information (e.g., experience, degree, title, previous projects worked on, algorithm familiarity).

The input may also include key factors. Alternatively, the key factors may be determined by the selection engine. The key factors may be derived from existing regulation related information and/or a historical analysis of previous assets.

Next, this information is processed (e.g., k-means distribution) to generate 404 a distribution, which allows a dissimilarity level for each of the candidates against the creator to be determined. Using the dissimilarity levels, the selection engine can identify 406 candidates to be selected 408 and included in the panel of reviewers. As a result, the panel of reviewers includes members that are most dissimilar from the creator. The panel of reviewers may also include randomly selected members that may or may not be dissimilar from the creator.

Embodiments of the invention, such as the examples disclosed herein, may be beneficial in a variety of respects. For example, and as will be apparent from the present disclosure, one or more embodiments of the invention may provide one or more advantageous and unexpected effects, in any combination. It should be noted that such effects are neither intended, nor should be construed, to limit the scope of the claimed invention in anyway. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, ethical and ethical-related operations, panel formation operations, bias evaluation operations, bias detection operations, or the like. More generally, the scope of the invention embraces any operating environment in which the disclosed concepts may be useful.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VM).

Particularly, devices in the operating environment may take the form of software, physical machines, containers, or VMs, or any combination of these, though no particular device implementation or configuration is required for any embodiment.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Following are some further example embodiments of the invention. These are presented only by way of example and are not intended to limit the scope of the invention in any way.

Embodiment 1. A method, comprising: receiving first input that includes information related to a creator of an asset in a selection engine, receiving second input that includes information related to candidates in the selection engine, determining key factors related to the asset by the selection engine, determining a dissimilarity level for each of the candidates against the creator by the selection engine, wherein the dissimilarity level is related to characteristics of the candidates, characteristics of the creator, and the key factors, and selecting, by the selection engine, a portion of the candidates to include in a panel of reviewers based on the dissimilarity level of each of the candidates, wherein the portion of the candidates are most dissimilar from the creator.

Embodiment 2. The method of embodiment 1, wherein the first input includes individual information including one or more of a gender, an age, an education level, a sexuality type, a political category, an ethnicity, languages, a title, and an industry, wherein the first input includes developer information including one or more of a company, an algorithm, past projects, and experience level.

Embodiment 3. The method of embodiment 1 and/or 2, wherein the first input includes data sets used in or by the asset, models or algorithms in or used by the asset, a product intent, a product industry, and personnel information associated with the creator, the creator including personnel including developers.

Embodiment 4. The method of embodiment 1, 2, and/or 3, further comprising determining the key factors based on a history that include factors associated with assets that are similar to the asset and a context of the asset.

Embodiment 5. The method of embodiment 1, 2, 3, and/or 4, wherein the portion of the candidates selected using the dissimilarity levels constitutes a first portion of the panel of reviewers.

Embodiment 6. The method of embodiment 1, 2, 3, 4, and/or 5, further comprising randomly selecting a second portion of the candidates to include in the panel of reviewers.

Embodiment 7. The method of embodiment 1, 2, 3, 4, 5, and/or 6, further comprising performing a random walk to randomly select the second portion of the candidates.

Embodiment 8. The method of embodiment 1, 2, 3, 4, 5, 6, and/or 7, further comprising receiving results of a review of the asset performed by the panel of reviewers.

Embodiment 9. The method of embodiment 1, 2, 3, 4, 5, 6, 7, and/or 8, further comprising storing information associated with selecting the panel of reviewers and results of the review in a historian.

Embodiment 10. The method of embodiment 1, 2, 3, 4, 5, 6, 7, 8, and/or 9, further comprising receiving additional input into the selection engine, the additional input including industry regulation and a historical analysis of bias and key factors.

Embodiment 11. A method for performing any of the operations, methods, or processes, or any portion of any of these, or any combination thereof, disclosed herein.

Embodiment 12. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

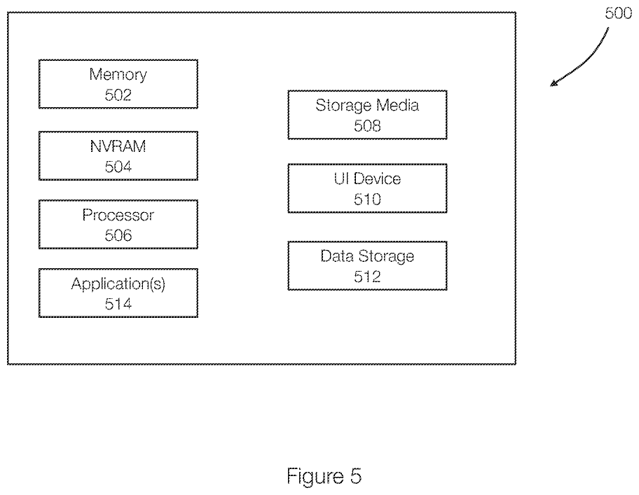

With reference briefly now to FIG. 5, any one or more of the entities disclosed, or implied, by the Figures and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid-state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving first input that includes first information related to a creator of an asset in a selection engine;
receiving, in a selection engine, second input that includes second information related to candidates;
determining key factors related to the asset by the selection engine;
determining a dissimilarity level for each of the candidates against the creator by the selection engine, wherein the dissimilarity level is related to the first information and the second information, which includes characteristics of the candidates, characteristics of the creator, and the key factors; and
selecting, by the selection engine, a portion of the candidates to include in a panel of reviewers based on the dissimilarity level of each of the candidates, wherein the portion of the candidates are most dissimilar from the creator.

2. The method of claim 1, wherein the first input includes individual information including one or more of a gender, an age, an education level, a sexuality type, a political category, an ethnicity, languages, a title, and an industry, wherein the first input includes developer information including one or more of a company, an algorithm, past projects, and experience level.

3. The method of claim 1, wherein the first input includes data sets used in or by the asset, models or algorithms in or used by the asset, an asset intent, an asset industry, and personnel information associated with the creator, the creator including personnel including developers.

4. The method of claim 3, further comprising determining the key factors based on a history that includes factors associated with assets that are similar to the asset and a context of the asset.

5. The method of claim 1, wherein the portion of the candidates selected using the dissimilarity levels constitutes a first portion of the panel of reviewers.

6. The method of claim 5, further comprising randomly selecting a second portion of the candidates to include in the panel of reviewers.

7. The method of claim 6, further comprising performing a random walk to randomly select the second portion of the candidates.

8. The method of claim 1, further comprising receiving results of a review of the asset performed by the panel of reviewers.

9. The method of claim 1, further comprising storing information associated with selecting the panel of reviewers and results of the review in a historian.

10. The method of claim 1, further comprising receiving additional input into the selection engine, the additional input including industry regulation and a historical analysis of bias and key factors.

11. A non-transitory storage medium having stored therein instructions that are executable by one or more hardware processors to perform operations comprising:
receiving first input that includes information related to a creator of an asset in a selection engine;
receiving, in the selection engine, second input that includes information related to candidates;
determining key factors related to the asset by the selection engine;
determining a dissimilarity level for each of the candidates against the creator by the selection engine, wherein the dissimilarity level is related to characteristics of the candidates, characteristics of the creator, and the key factors; and
selecting, by the selection engine, a portion of the candidates to include in a panel of reviewers based on the dissimilarity level of each of the candidates, wherein the portion of the candidates are most dissimilar from the creator.

12. The non-transitory storage medium of claim 11, wherein the first input includes individual information including one or more of a gender, an age, an education level, a sexuality type, a political category, an ethnicity, languages, a title, and an industry, wherein the first input includes developer information including one or more of a company, an algorithm, past projects, and experience level.

13. The non-transitory storage medium of claim 11, wherein the first input includes data sets used in or by the asset, models or algorithms in or used by the asset, an asset intent, an asset industry, and personnel information associated with the creator, the creator including personnel including developers.

14. The non-transitory storage medium of claim 13, further comprising determining the key factors based on a history that include factors associated with assets that are similar to the asset and a context of the asset.

15. The non-transitory storage medium of claim 11, wherein the portion of the candidates selected using the dissimilarity levels constitutes a first portion of the panel of reviewers.

16. The non-transitory storage medium of claim 15, further comprising randomly selecting a second portion of the candidates to include in the panel of reviewers.

17. The non-transitory storage medium of claim 16, further comprising performing a random walk to randomly select the second portion of the candidates.

18. The non-transitory storage medium of claim 11, further comprising receiving results of a review of the asset performed by the panel of reviewers.

19. The non-transitory storage medium of claim 11, further comprising storing information associated with selecting the panel of reviewers and results of the review in a historian.

20. The non-transitory storage medium of claim 11, further comprising receiving additional input into the selection engine, the additional input including industry regulation and a historical analysis of bias and key factors.
